(19) United States
(12) Patent Application Publication
(10) Pub. No.: US 2002/0023941 A1
(43) Pub. Date: Feb. 28, 2002

(54) Friction stir bonding method, and hollow-shaped material thereof

(76) Inventors: Masakuni Ezumi, Kudamatsu (JP); Kazushige Fukuyori, Kudamatsu (JP); Hisanori Okamura, Naka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/791,552

(22) Filed: Feb. 26, 2001

(30) Foreign Application Priority Data
Aug. 29, 2000 (JP) 2000-259053

(51) Int. Cl. B23K 20/12

(52) U.S. Cl. 228/112.1; 228/2.1

(57) ABSTRACT

The object of the present invention is to provide a friction stir bonding method of a tubular portion such as a hollow-shaped material and the like which does not deform the same during friction stir bonding.

Face plates 11b, 12b of a hollow-shaped material 10 are abutted against face plates 21b, 22b of a hollow-shaped material 20. The end surfaces of the face plates 11b, 12b includes a concave portion 16, and the end surfaces of the face plates 21b, 22b includes a convex portion 26 to be inserted to the concave portion. To outer sides of the face plates 11b, 12b, 21b and 22b, there exist concave portions 15, 25. A rotary tool 50 includes a small-diameter portion 51 between a large-diameter portion 53 and a large-diameter portion 54. The outer surface of the small-diameter portion 51 is formed with a screw. A friction stir bonding is performed by interposing the region to be bonded between the two large-diameter portions 53, 54. By using this method, the stress toward the central portion of the hollow-shaped materials 10, 20 does not exist, so that friction stir bonding could be performed without deforming the hollow-shaped materials 10, 20.

### FIELD OF THE INVENTION

The present invention relates to a friction stir bonding method of a tubular portion, and more particular, to a preferred bonding method of a hollow-shaped material.

### DESCRIPTION OF THE RELATED ART

A friction stir bonding method is a technique using a round shaft (called a rotary tool) being inserted in the bonding region of members and moving the rotating rotary tool along the junction line, thereby heating, mobilizing and plasticising the bonding region, and realizing a solid-phase bonding of the members. The rotary tool comprises a large-diameter portion and the small-diameter portion. The small-diameter portion is inserted to the member to be bonded, and the end surface of the large-diameter portion is in contact with the member. A screw is formed to the small-diameter portion. Moreover, a friction stir bonding may be performed by positioning a member to be bonded between two large-diameter portions of the rotary tool. This technique is disclosed in Gazette of Japanese Patent No. 2,712,838 (U.S. Pat. No. 5,460,317), and Japanese Patent National Publication of PCT Application No. 9-508073 (EP 0752926B1).

The rotary tool must be inserted to the metal in the bonding region, therefore the bonding region is subjected to intense stress. Therefore, in order to bond hollow-shaped materials together, the place where the two face plates of the hollow-shaped material is connected by the connecting plates is set as the region to be friction stir bonded with the other hollow-shaped material. The friction stir bonding is performed while supporting the above-mentioned stress with the above-mentioned connecting plates, in order to prevent deformation of the hollow-shaped material. This technique is disclosed in Japanese Patent Laid-Open Publication No. 11-90655 (U.S. Pat. No. 6,050,474).

### SUMMARY OF THE INVENTION

The technique disclosed in the above-mentioned Japanese Patent Laid-Open Publication No. 11-90655 (U.S. Pat. No. 6,050,474) enables friction stir bonding while preventing deformation of the hollow-shaped material. However, the connecting plate must exist at the region to be friction stir bonded, so that the place for the friction stir bonding or the shape of the hollow-shaped material is restricted. This results in increase in weight of the hollow-shaped material.

The object of the present invention is to provide a friction stir bonding method of tubular portion such as a hollow-shaped material and the like, which does not deform during friction stir bonding.

The present invention is characterized in butting a face plate of a hollow-shaped material against a plate to be bonded thereto, and performing friction stir bonding while positioning the butted region between two large-diameter portions of a rotary tool.

### BRIEF DESCRIPTION OF THE DRAWINGS

FIG. 1 is a longitudinal cross-sectional view of a pair of hollow-shaped materials according to one embodiment of the present invention;

FIG. 2 is an enlarged longitudinal cross-sectional view of a region to be bonded of the hollow-shaped material in FIG.

FIG. 3 is a longitudinal cross-sectional view of a main section during bonding in FIG. 1;

FIG. 4 is a longitudinal cross-sectional view of a main section after bonding in FIG. 1;

FIG. 5 is a disassembled longitudinal cross-sectional view of a rotary tool in FIG. 1;

FIG. 6 is a perspective view of a car body of a railway car; and

FIG. 7 is a front view of another embodiment of the present invention.

### DETAILED DESCRIPTION OF PREFERRED EMBODIMENTS

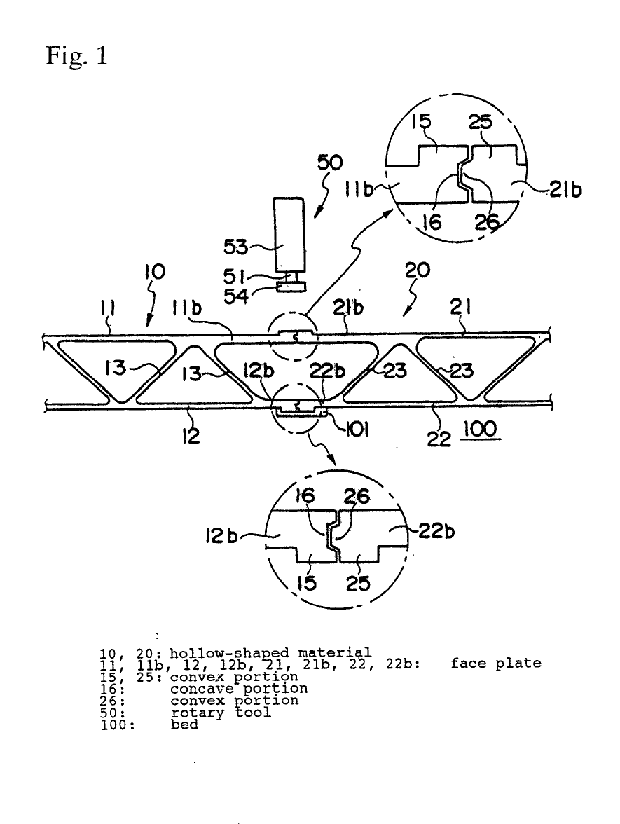

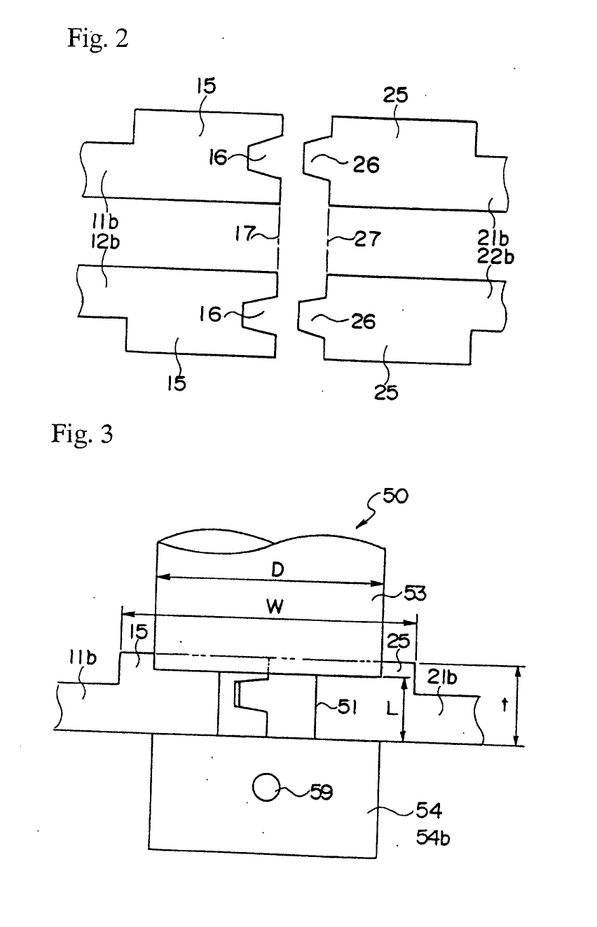

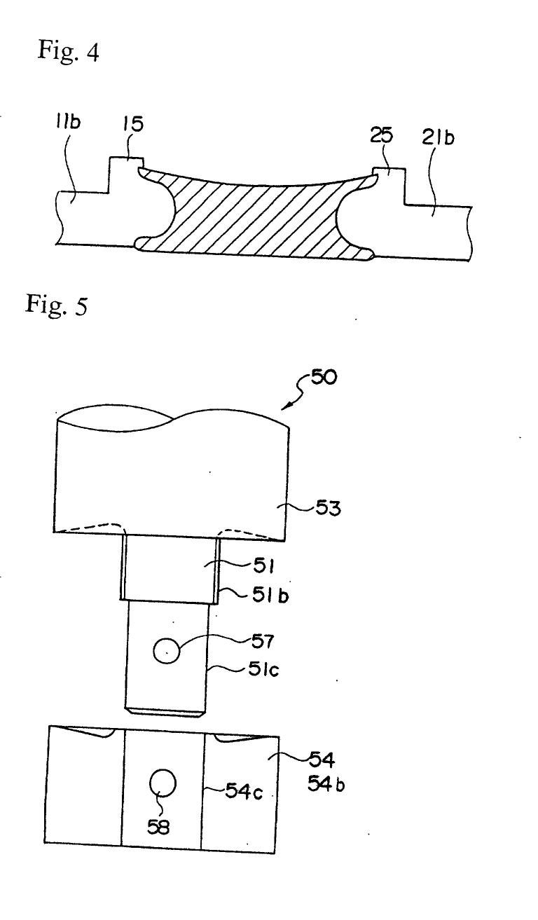

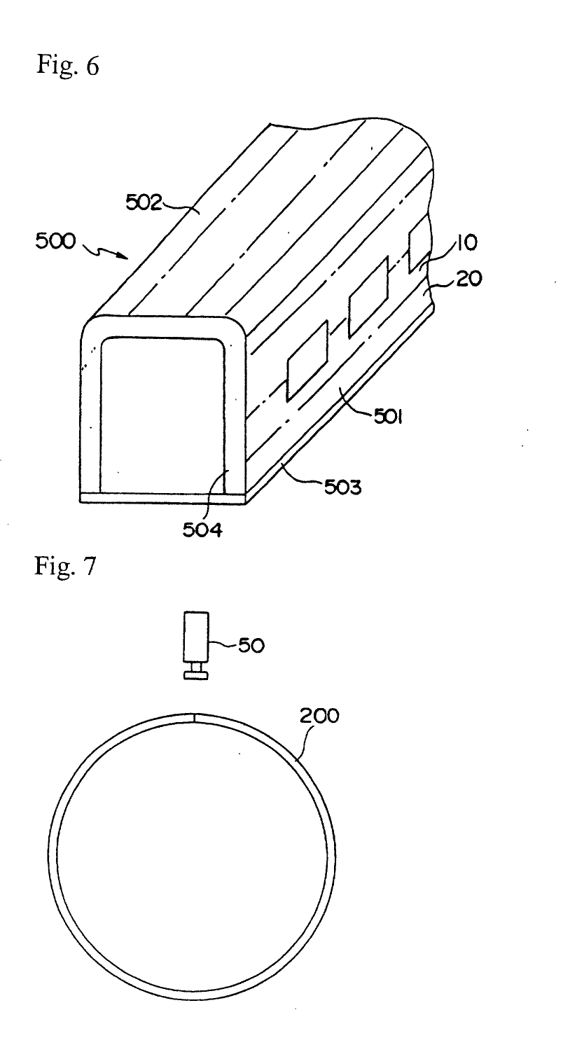

A preferred embodiment of the present invention will now be explained with reference to FIGS. 1 through 6. In FIG. 4, the shape of the bonding region or the friction stir area shown by the hatchings is shown as an exemplification.

A car body 500 of a railway car is comprised of a side structure 501 constituting the side surface, a roof structure 502 constituting the roof, an underframe 503 constituting the floor, and an end structure 504 constituting the end portion in the longitudinal direction. The side structure 501, the roof structure 502, and the underframe 503 are formed by bonding plural extruded materials 10, 20, respectively. The longitudinal direction (extruded direction) of the extruded materials 10, 20 is positioned toward the longitudinal direction of the car body 500. The extruded materials 10, 20 are hollow-shaped materials made of aluminum alloy.

The structure of the hollow-shaped materials 10, 20 constituting the side structure 501 will now be explained. The same applies to the hollow-shaped materials used in other structures.

The hollow-shaped material 10 (20) is comprised of two substantially parallel face plates 11 (21), 12 (22), and plural connecting plates 13 (23) connecting the two face plates. The connecting plates 13 (23) are inclined from face plates 11 (21), 12(22). That is, the face plates 11 (21), 12 (22) and the connecting plates 13 (23) constitutes a truss.

The end portion in the width direction of the hollow-shaped material 10 (20) protrudes from the joint section of the connecting plate 13 (23) and the face plates 11, 12 (21, 22) so as to form face plates 11b, 12b (21b, 22b). The outer surfaces of the face plates 11b, 12b (21b, 22b) constitutes the same plane with the outer surfaces of the face plates 11, 12 (21, 22). The thickness of the face plates 11b, 12b (21b, 22b) are thicker than the thickness of face plates 11, 12 (21, 22).

To the end portions of the face plates 11b, 12b (21b, 22b), there is provided a convex portion 15 (25) projecting to the outer surface direction (outer side in the thickness direction) of the hollow-shaped materials 10, 20. Also, a concave portion 16 is formed on the end surfaces of the face plates 11b, 12b. To the end surfaces of the face plates 21b, 22b of the other hollow-shaped material 20, there is provided a convex portion 26 to be inserted to the concave portion 16. In order to ease insertion of the convex portion 26 to the concave portion 16, the concave portion 16 and the convex portion 26 takes the trapezoid shape. When inserted, there exists some gap between the bottom surface of the concave portion 16 and the leading end of the convex portion 26.

The friction stir bonding is performed to the region in the condition where the concave portion 16 and the convex portion 26 are fitted together. Therefore, this bonding region could be said that it is a bonding of a tubular portion comprised of face plates 11, 21 (12, 22) and connecting plates 13, 23. In this case, the tube may not be a complete tube. For example, the bonding region in a case such as bonding a plate to the end portion of the face plate 11 of the hollow-shaped material 10 could be called bonding of a tube. That is, a case where supporting member for supporting the insertion force of the rotary tool does not exist at the bonding region is called a tube.

Each of the end surface 17 of the face plates 11, 12 of the hollow-shaped material 10 exists on a line orthogonal to the surface of the face plates 11b, 12b (on a line along the thickness direction of the hollow-shaped material). Two end surfaces 17 exists on a same line.

Each of the end surface 27 of the face plates 21, 22 of the hollow-shaped material 20 exists on a line orthogonal to the surface of the face plates 21b, 22b (on a line along the thickness direction of the hollow-shaped material). Two end surfaces 27 exists on a same line. The projections of the convex portions 26 are equal in size.

The overlap of the concave portion 16 and the convex portion 26 of the face plates 12b, 22b on the lower side may be formed to be larger than the overlap of the concave portion 16 and the convex portion 26 of the face plates 11b, 21b on the upper side. By doing so, the concave portion 16 and the convex portion 26 on the upper side are fitted together after the concave portion 16 and the convex portion 26 on the lower side are fitted together, so that fitting on the upper side could be performed with ease.

The length of the face place from the connecting plate at the end portion of the hollow-shaped material 10 to the connecting plate 23 of the other hollow-shaped material is longer than the length of the face plate constituting a truss in other areas. Therefore, the thickness of the face plates 11b, 12b, 21b and 22b at the bonding region is thickened slightly.

The rotary tool 50 includes large-diameter portions 53, 54 on both sides of a small-diameter portion 51 in the axial direction. The friction stir bonding is performed by rotating the rotary tool 50 while interposing the region to be bonded between the two large-diameter portions 53, 54. The outer surface of the small-diameter portion 51 is provided with a male screw. To the upper end of the rotary tool 50, there is provided a driving device for rotating and moving the tool. Of the two large-diameter portions 53, 54, the upper large-diameter portion 53 is called a large-diameter portion 53 on the base axis side (or on the driving device side). The lower large-diameter portion 54 is called a large-diameter portion 54 on the leading end side.

The member of the rotary tool 50 is comprised of a cylindrical rod 50b including the large-diameter portion 53 and the small-diameter portion 51, and a member 54b for the large-diameter portion 54 on the leading end. The cylindrical rod 50b includes, from the base end side, the large-diameter portion 53 having the circular outside diameter, a small-diameter screw portion 51b, and a small-diameter axis portion 51c for installing the member 54b of the large-diameter portion 54. The axis portion 51c is provided with a pin hole 57 for fixing the member 54b.

The member 54b corresponding to the large-diameter portion 54 has a circular outside diameter, and is equipped with a hole 54c fitting with the axis 51c, and a pin hole 58. Each of the end surfaces of the large-diameter portions 53, 54 on the side of the screw portion 51b has an inclined concave as is illustrated in FIG. 5. The concave exists for the function of keeping the stirred metal to the inner side, and preventing outflow of the metal to exterior.

After producing the parts as is explained above, the member 54b corresponding to the large-diameter portion 54 is fitted to the axis 51c, and the member 54b is fixed by fitting the knock pin 59 to the pin holes 57, 58. The member 54b becomes the large-diameter portion 54.

The length L of the small-diameter portion 51 (distance from the end surface of the large-diameter portion 53 to the end surface of the large-diameter portion 54) is smaller than the thickness t of the member to be bonded (including convex portions 15, 25). The diameter D of the large-diameter portion 53 is smaller than the width W of two convex portions 15, 25 added together.

Next, the bonding process of the two hollow-shaped materials will be explained. Two hollow-shaped materials 10, 20 are placed on a bed 100, and the face plates 11b, 12b of the hollow-shaped material 10 are abutted against the face plates 21b, 22b of the other hollow-shaped material 20. By doing so, the convex portions 26 of the face plates 21b, 22b enter the concave portions 16 of the face plates 11b, 12b. The hollow-shaped materials 10, 20 are fixed to the bed 100 in such state. Also, the upper convex portions 15, 25 are ark welded together intermittently.

Under such circumstance, the rotary tool 50 is rotated and moved from the end surface in the longitudinal direction of the hollow-shaped materials 10, 20 toward the side of the hollow-shaped materials 10, 20, and holds the region to be bonded between the two large-diameter portions 53, 54 (the small-diameter portion 51). The region to be bonded is bonded with the movement of the rotary tool 50.

After completing the bonding on the side of the face plates 11, 21, the hollow-shaped materials 10, 20 are turned upside-down, and are fixed on the bed 100 with the face plates 11, 21 downward. The butted region of the face plates 12b, 22b is subjected to friction stir bonding, as is mentioned above.

During friction stir bonding, the rotary tool 50 is slightly inclined, as is well-known in the art. The axial center of the rotary tool is inclined rearward against the direction of movement of the rotary tool 50. The front end of the upper large-diameter portion 53 (front in the direction of movement mentioned above) is positioned upward from the rear end (rear in the direction of movement mentioned above).

The rear end of the upper large-diameter portion 53 is positioned inside the convex portions 15, 25. By saying that the rear end of the large-diameter portion 53 is positioned inside the convex portions 15, 25, it means that the rear end of the large-diameter portion 53 is positioned upward from the outer surfaces of the face plates 11b, 21b excluding the convex portions 15, 25.

By doing to, the friction stir bonded surface on the upper side is positioned upward from the upper surfaces of the face plates 11b, 21b (12b, 22b). When using the upper surfaces of the face plates 11, 21 as the outer surfaces of the car body, remaining convex portions 15, 25 are cut out to constitute the same plane with the face plates 11b, 21b. The convex portions 15, 25 in the inner side of the car body are cut out according to need.

In friction stir bonding, the gap in the region to be bonded (for example, a gap between the concave portion 16 and the convex portion 26, a gap between the end surface 17 and the end surface 27) is filled using metal in the convex portions 15, 25 as the source. Remaining metal is ejected from the perimeter of the large-diameter portion 53. It is easy for the above-mentioned gap to be formed, because the length of the car body 500 is approximately 20 meters.

The large-diameter portion 54 of the leading end is positioned below the face plates 11b, 21b. The front end of the large-diameter portion 54 scrapes the lower surface of the face plates 11b, 21b slightly, but the metal is raised slightly at the rear end of the large-diameter portion 54. The metal is raised downwardly in FIG. 4.

The length of the car body 500 is approximately 20 m, so that the face plates 11b, 12b, 21b and 22b tends to deform slightly in the thickness direction of the hollow members 10, 20. However, the two face plates 11b, 21b are fitted together at the concave portion 16 and the convex portion 26, so that unevenness caused from the difference of the height position of the end portion of the face plate 11b and the height position of the end portion of the face plate 21b at the region to be bonded does not occur. When unevenness occurs, gaps tend to be formed in the interior of the bonded region. Therefore, by fitting, a friction stir bonding having little defect could be obtained.

During friction stir bonding, the two face plates are held between the two large-diameter portions 53, 54, so that a stress caused from inserting the rotary tool 50 towards the side of the face plates 12, 22 does not occur during bonding of the side of the face plates 11b, 21b. Therefore, the hollow-shaped material could be bonded without deforming the same, even though there exists no supporting plate at the bonding region.

In the above-mentioned embodiment, the concave portion 16 is formed on each of the face plates 11b, 12b of the hollow-shaped material 10, and convex portion 26 is formed on each of the face plates 21b, 22b of the other hollow-shaped material 20. However, it is also possible to form the concave portion 16 on each of the face plates 11b, 22b, and the convex portion 26 on each of the face plates 12b, 21b. Also, it is also possible to form the convex portion 15 on only one member of the abutted region.

The embodiment illustrated in FIG. 7 is a case where end portion of a cylinder 200 formed by bending a plate circularly is friction stir bonded to obtain a cylinder. The above-mentioned rotary tool 50 is used as the rotary tool. When bonding with the ordinary rotary tool, bonding is performed while a supporting member is placed inside the cylinder. Or, bonding is performed by positioning the bonding region downward, and placing the rotary tool inside the cylinder. In such cases, bonding of a small-diameter cylinder is difficult, since the placement of a supporting member or a rotary tool is difficult. However, by performing bonding by placing the region to be bonded between the two large-diameter portions, a small-diameter cylinder could be bonded with simple structure.

Not only to cylinders, but it could also be applied to tubes bent in square shape and the like. Moreover, it could be applied to cases for bonding in the circumferential direction. For example, it could be applied to the case of butting the first cylinder against the second cylinder in the axial direction, and bonding the same in the circumferential direction. In this case, a hole for inserting the large-diameter portion 54 of the leading end of the rotary tool is formed at the starting point of the bonding, and bonding is completed at the position of the hole. After completing the bonding, the hole is filled by ark welding. Or, an application plate is ark welded thereto.

The technical scope of the present invention is not limited to the terms used in the claims or in the summary of the present invention, but is extended to the range in which a person skilled in the art could easily substitute based on the present disclosure.

The present invention could perform friction stir bonding without deforming a tube such as a hollow-shaped material and the like.

We claim:

1. A friction stir bonding method, the method comprising:
butting an end portion of a face plate on one side of a hollow-shaped material against an end portion of a first plate; and
using a rotary tool having a large-diameter portion on either end of a small-diameter portion, rotating and moving said rotary tool along said butted region while interposing said butted region between said two large-diameter portions of said rotary tool.

2. A friction stir bonding method according to claim 1, wherein:
members in said butted region include a pair of concave and convex portions, and the members are abutted against each other while inserting said convex portion on one member to said concave portion on the other member; and
friction stir bonding is performed in such state using said rotary tool.

3. A friction stir bonding method according to claim 1, wherein:
an external surface of the end portion of said face plate is provided with a convex portion; and
said friction stir bonding is performed while inserting a large-diameter portion on the base axis side of said rotary tool inside said convex portion.

4. A friction stir bonding method, the method comprising:
butting two face plates of a first hollow member against two face plates of a second hollow-shaped material; and
using a rotary tool having a large-diameter portion on either end of a small-diameter portion, rotating and moving said rotary tool along said butted region while interposing said butted region between said large-diameter portion and said large-diameter portion of said rotary tool.

5. A friction stir bonding method according to claim 4, wherein:
members in each of said butted region include a pair of concave and convex portions, and the members are abutted against each other while inserting said convex portion on one member to said concave portion on the other member; and
friction stir bonding is performed in such state using said rotary tool.

6. A friction stir bonding method according to claim 4, wherein:
each of external surfaces of the end portions of said two face plates of said first hollow member and each of external surfaces of the end portions of said two face plates of said second hollow member are provided with a convex portion; and
said friction stir bonding is performed while inserting a large-diameter portion on the base axis side of said rotary tool inside said convex portion.

7. A friction stir bonding method, the method comprising:
bending a plate to form a tubular shape, and butting one end portion of said plate against the other end portion; and
using a rotary tool having a large-diameter portion on either end of a small-diameter portion, rotating and moving said rotary tool along said butted region while interposing said butted region between said two large-diameter portions of said rotary tool.

8. A friction stir bonding method, the method comprising:
butting a first cylinder against a second cylinder; and
using a rotary tool having a large-diameter portion on either end of a small-diameter portion, rotating and moving said rotary tool along said butted region while interposing said butted region between said two large-diameter portions of said rotary tool.

9. A structural body, wherein:
butted region of an end portion of a face plate on one side of a hollow-shaped material and an end portion of a first plate is friction stir bonded;
said friction stir bonded region exists on both sides in the direction of thickness of the bonded region; and
said friction stir bonded region at the side facing the other face of said other hollow member is raised from said face plate on one side and the surface of said first face plate.

10. A tube, wherein:
friction stir bonding is performed in the direction along the axial direction of a tube;
said friction stir bonded region exists on both sides in the direction of thickness of the bonded region; and
said friction stir bonded region at the side facing the inner side of said tube is raised from a plate constituting said tube.

11. A tube, wherein:
butted region between a first tube and a second tube is bonded with friction stir bonding;
said friction stir bonded region exists on both sides in the direction of thickness of the bonded region; and
said friction stir bonded region at the side facing the inner side of said tube is raised from a plate constituting said tube.

12. A hollow-shaped material for friction stir bonding, wherein:
said hollow-shaped material comprises a first face plate, a second face plate substantially parallel to said first face plate, and a plural connecting plates connecting said first face plate and said second face plate;
an end portion of said first face plate and an end portion of said second face plate is protruded in the width direction of said hollow-shaped material compared to the connecting region of said connecting plate with said first face plate and said second face plate;
an end surface of said protruded end portion of said first face plate includes a concave portion or a convex portion; and
an end surface of said protruded end portion of said second face plate on the side facing said concave portion or said convex portion includes a concave portion or a convex portion.

13. A hollow-shaped material for friction stir bonding according to claim 12, wherein each of said first face plate and said second face plate being protruded includes at the outer surfaces thereof with a second convex portion.
